(19) United States
(12) Patent Application Publication
(10) Pub. No.: US 2015/0134524 A1
(43) Pub. Date: May 14, 2015

(54) Real-Time External Financial Account Verification

(71) Applicant: STATE FARM MUTUAL AUTOMOBILE INSURANCE COMPANY, Bloomington, IL (US)

(72) Inventors: Mark Comer Kaufman, Champaign, IL (US); Kay Schnell Larrison, McLean, IL (US); Latricia Faye Johnson, Normal, IL (US)

(73) Assignee: STATE FARM MUTUAL AUTOMOBILE INSURANCE COMPANY, Bloomington, IL (US)

(21) Appl. No.: 14/078,164

(22) Filed: Nov. 12, 2013

(51) Int. Cl. G06Q 40/00; G06Q 20/40

(52) U.S. Cl. CPC G06Q 40/02; G06Q 20/40
USPC 705/44

(57) ABSTRACT

Methods and systems for providing real-time external account validation during the opening of a new financial account include receiving external account information and validation information for use in validating that an account owner corresponding to the new financial account is associated with an external financial account provided by an external institution. The received information may be electronically transmitted to the external institution, and the external institution may respond with an electronic indication of an affirmative validation. Upon reception of the affirmative validation, an electronic funds transfer from the external account to new financial account may be initiated. The real-time external account validation may be performed in real-time, e.g., during a single business day or during a single session established with a computer of the institution providing the new financial account.

### FIELD OF THE DISCLOSURE

This disclosure generally relates to real-time external financial account validation, verification or confirmation during the process of opening a new financial account.

### BACKGROUND

Some parties choose to fund a new financial account via an electronic funds transfer (EFT) from a source financial account that is provided by an institution other than the institution providing the new financial account. In this scenario, before an EFT can take place, the source financial account must be validated, verified or confirmed as being owned by or associated with the applicant or owner of the new financial account. Current methods of source account validation typically utilize micro-deposits. A micro-deposit is a small deposit amount (typically under $1.00 in United States currency) which is made to the source financial account. In some cases, multiple micro-deposits are made. The account owner of the source financial account must independently verify that the micro-deposit(s) took place, and optionally, must verify the amount of the micro-deposit(s). After verification, the account owner notifies the institution providing the new financial account of the occurrence (and optionally, the amount) of the micro-deposit(s). The providing financial institution initiates the EFT from the source financial account to the new financial account only after it has received affirmative confirmation of the micro-deposit(s). Typically, this entire validation process takes multiple days to complete. For example, a micro-deposit typically takes two or more business days to appear in a source financial account. Further, the account owner must remember to access the source account and notify the providing institution, which may incur further delay.

### SUMMARY

In an embodiment, a method of opening financial accounts in real-time includes receiving a request to open a new financial account provided by a first institution, and receiving a request to fund the new financial account using an electronic funds transfer from a source financial account. The source financial account may be provided by an institution other than the institution providing the new financial account, e.g., the source financial account may be an “external” source financial account provided by an “external” institution. The method further includes receiving information indicative of the external source financial account, and receiving validation information indicative of the party under whose name the new financial account is applied for and opened, e.g., the owner of the new account. The received information may be transmitted to another computing device at the external institution for validation that the user is associated with the source financial account.

Additionally, the method includes receiving a confirmation that the owner of the new account is validated or verified as being associated with the source financial account, e.g., receiving an electronic confirmation. Upon receiving the confirmation, the electronic funds transfer from the source financial account to the new financial account may be initiated. The method may be performed during a single business day, and in some cases, the method may be performed during a single session established with a computing device of the institution providing the new financial account.

An embodiment of a system for opening a financial account in real-time includes at least one computing device having a processor, a memory, a user interface, and a network interface. The system additionally includes a set of computer-executable instructions stored on the memory and executable by the processor to cause the system to receive, via the network interface or the user interface, a first request to open a new financial account for a party, where the new financial account is provided or offered by a first institution. The system may also receive, via the network interface or the user interface, a second request to fund the new financial account by an electronic funds transfer from a source financial account, where the source financial account is provided by a second institution different from the first institution. Additionally, the system may receive, via the network interface or the user interface, (i) information indicative of the source financial account and (ii) validation information indicative of the party, and the system may cause the information (i) and (ii) to be transmitted via the network interface to a second computing device, corresponding to the second institution, for confirmation that the party is associated with the source financial account.

Further, the system may receive, via the network interface, an electronic indication that the party has been validated, verified or confirmed as being associated with the source financial account. The electronic indication may be generated by the second computing device or by a third computing device corresponding to the second institution. Upon receiving the electronic indication, the system may initiate, via the network interface, the electronic funds transfer from the source financial account to the new financial account. The system may perform the above during a single business day, e.g., during a single session established with at least one computing device of the institution providing the new financial account.

An embodiment of a system for opening, in real-time, a new financial account at a first institution includes a processor and a program memory storing executable instructions that, when executed by the processor, cause the system to establish a session corresponding to a user. During the established session, the executable instructions may further cause the system to receive a first request to open, for an applicant or new account owner, the new financial account at the first institution, and receive a second request to fund the new financial account by an electronic funds transfer from a source financial account, where the source financial account is provided by a second institution different than the first institution. Additionally, the system may receive (i) information indicative of the source financial account, and (ii) validation information indicative of the applicant or new account owner, and may cause the information (i) and (ii) to be electronically transmitted via a network to a computing device of the second institution for validation, verification or confirmation that the applicant or new account owner is associated with the source financial account at the second institution. Further, the system may receive a confirmation (e.g., an electronic confirmation) generated at the second institution, where the confirmation indicates that the applicant or new account owner is associated with the source financial account. Upon receiving the confirmation, the system may cause the initiation of the electronic funds transfer from the source financial account to the new financial account.

### BRIEF DESCRIPTION OF THE DRAWINGS

FIG. 1 is an example method of opening a financial account in real-time;

FIG. 2 is an example block diagram of a system for opening a financial account in real-time; and

FIG. 3 is an example scenario of opening a financial account in real-time.

### DETAILED DESCRIPTION

It should be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

The novel methods, techniques and systems disclosed herein generally relate to providing real-time external financial account validation during a process of opening a new financial account, e.g., during a process of electronically opening a new financial account. A new financial account may be initially funded by an electronic fund transfer (EFT) from an existing financial account, where the existing financial account is provided by an institution other than the institution providing the new financial account. As such, financial accounts provided by institutions other than the institution providing the new financial account are generally referred to herein as “external” accounts, as they are external to the institution that is holding, offering or providing the new account. Additionally, an existing financial account that is a source of the contribution or funds for a new financial account is also generally referred to herein as a “source” account.

The term “financial account,” as used herein, generally refers to any account into which an account owner may deposit (and in some cases withdraw) money or currency. A financial account may be, for example, a deposit account such as a checking account, a savings account, a money market account, a time deposit account (such as certificate of deposit (CD)), or other type of deposit account. A financial account may be a bank account or an investment account. In some scenarios, a financial account may be a pre-paid currency card such as a gift card or other type of stored value card.

A financial account may be provided or held by an institution, e.g., a financial institution. As generally referred to herein, an “institution” may be, for example, a bank, a credit union, an investment firm, a governmental agency, an e-commerce business or e-commerce entity, or other institution that provides financial accounts to customers, members, or other parties.

The terms “validate,” “verify,” and “confirm” may be used interchangeably herein. For example, when an external institution attempts to validate, verify or confirm that a particular party is associated with an account, the external institution may ascertain that, indeed, the particular party is associated with the account. Consequently, the external institution may validate, verify or confirm the association between the particular party and the account, e.g., the external institution may provide an affirmative validation, verification or confirmation. On the other hand, the external institution may ascertain that the particular party is not associated with the account. In this scenario, the external institution may indicate that the association between the particular party and account does not exist, e.g., the external institution may provide a negative validation, verification or confirmation.

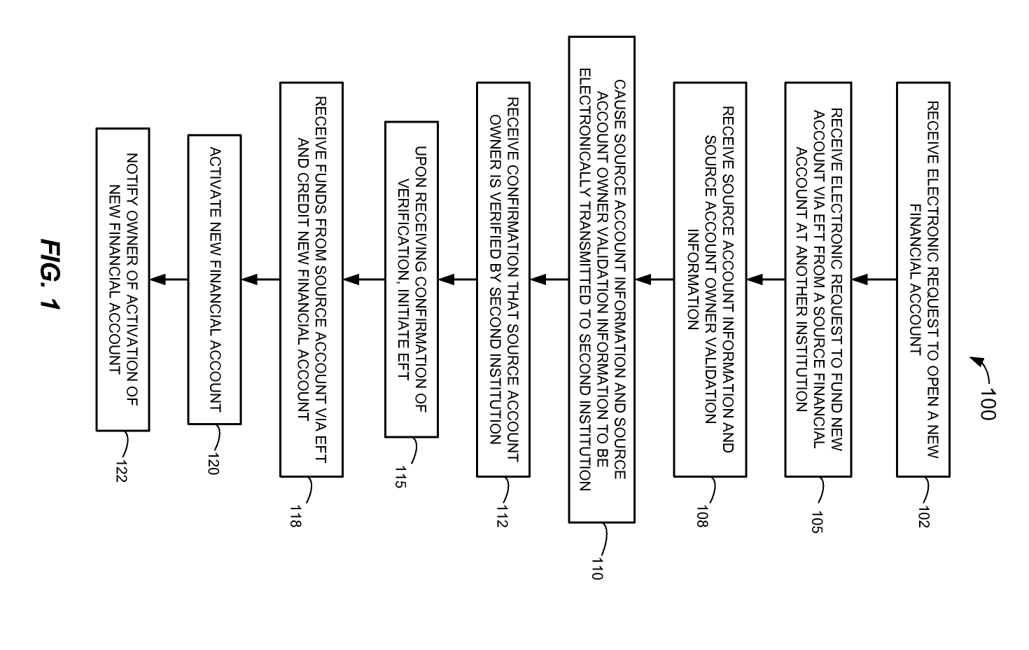

FIG. 1 is an example method 100 for opening a financial account in real-time. At least a portion of the method 100 may be performed by one or more computing devices, in an embodiment. In an embodiment, the one or more computing devices are owned, administrated, managed by, or otherwise associated with an institution. For example, the one or more computing devices may be located within a branch of a bank, or the one or more computing devices may be a website hosted by a single computing device or a plurality of networked computing devices, e.g., a computing cloud.

The method 100 may include receiving a request to open a new financial account at an institution (block 102). The new financial account may be offered, held at or provided by the institution, and as such, the institution providing the new financial account is generally referred to herein a “providing” institution.

The new financial account may be applied for and opened by a user, such as an applicant or an owner of the new financial account. Typically, the term “applicant” refers to a party under whose name the new financial account is applied for, and the term “owner” refers to the same party after the new financial account has been opened or approved. Accordingly, the terms “applicant,” “owner of the new financial account,” “owner of the new account,” and “new account owner” are used interchangeably herein to refer to the party whose name is on the new financial account. A “user,” as used herein, generally refers to the party performing the applying for and/or the opening of the new financial account, which may be the applicant/new account owner, or may be an agent thereof (e.g., a custodian, a trustee, a sales associate or agent of the institution providing the new financial account, etc.).

In an embodiment, the request to open the new account is received via a user interface of a computing device. The computing device may be, for example, a mobile computing device such as a smart device, tablet computing device or laptop. The computing device may be a stationary computing device in a home, office, call center, or other location. In an embodiment, the request to open the new account is received via a website, e.g., a website portal for electronically opening accounts at the providing institution. As such, the request may be an electronic request received via the user interface of the computing device utilized by the user and one or more networks (e.g., the Internet and/or other public or private network(s)).

At a block 105, the method 100 may include receiving a request to fund or provide an initial contribution of the new financial account by electronically transferring funds from a source financial account that is not provided by the providing institution, e.g., from an external source financial account. In an embodiment, the request to fund the new account using electronic transfer is received via a user interface of a computing device. In an embodiment, the request to fund the new account is received via a website, e.g., the website portal for electronically opening accounts at the providing institution. As such, the request may be an electronic request received via one or more networks (e.g., the Internet and/or other public or private network(s)). The external, source financial account may correspond to the applicant, new account owner or user of the new financial account. Although in FIG. 1 the request of block 102 and the request of block 105 are illustrated as being two distinct and separate requests, in an embodiment, the content of the requests of the block 102 and the block 105 may be combined into a single, integral request.

At block 108, the method 100 may include receiving information indicative of the external, source financial account. For example, an account number or identifier of the external, source financial account may be received, and/or a routing number, electronic address, account key, user-selected or user-provided identifier, or other identifier of the external institution providing the source financial account may be received.

Further at block 108, the method 100 may also include receiving information indicative of the applicant or new account owner for validation purposes. For example, the applicant or new account owner may enter or provide the information indicative of himself or herself. The validation information may include any information that ties or relates the applicant or new account owner to the external source account at the external institution. Typically, the validation information is private information of the applicant or new account owner. For example, the validation information may include a login and/or password that the applicant or new account owner utilizes to access the external source account. In another example, the validation information excludes the login and/or the password of the external source account, but includes other identifiers corresponding to applicant or new account owner, such as a social security number or other numerical identifier, answers to one or more security questions, and/or other identifiers such as birth date, mailing address, phone number, email address, etc. In an embodiment, the type of validation information that is to be received (block 108) may be specified by the external institution.

In an embodiment the received information (block 108) is integrally received with the request to fund the new financial account via EFT (block 105). In an embodiment, the received information (block 108) is received in response to a user interface prompt. For example, after receiving the request to electronically transfer funds into the new account (block 105), a prompt or request for the information indicative of the external, source financial account and for the information indicative of the applicant, new account owner, or user may be presented at a user interface, and the requested information may be received (block 108) in response to the presented prompt or request. In an embodiment, the received information (block 108) may be stored in one or more data storage devices, e.g., one or more data storage devices that are accessible to the one or more computing devices corresponding to the providing institution.

Turning to block 110, the method 100 may include causing the information indicative of the external, source financial account and the information indicative of the applicant or new account owner to be transmitted or delivered to the external institution. In an embodiment, the information may be electronically transmitted or delivered, e.g., over the Internet and/or one or more other public or private networks to one or more computing devices associated with the external institution. In an embodiment, an indication that validation information for the external, source financial account has been received and/or transmitted to the external institution is stored, e.g., is stored in one or more data storage devices that are accessible to the one or more computing devices corresponding to the providing institution.

The external institution may utilize the information indicative of the external, source financial account and the information indicative of the applicant or new account owner to validate, verify or confirm that the applicant or new account owner is indeed associated with the external, source financial account, and/or that the applicant or new account owner has withdrawal privileges for the external, source financial account. For example, the external institution may validate, verify or confirm that the applicant or new account owner is an owner, trustee, or custodian of the external, source financial account. The external institution may manually perform the validation (e.g., by utilizing a person to perform database lookups), or the external institution may automatically perform the validation (e.g., by utilizing one or more computing devices without any human intervention). Upon an affirmative validation, the external institution may cause a confirmation to be transmitted or delivered to the providing institution. In an embodiment, a computing device of the external institution causes an electronic confirmation to be transmitted or delivered, via one or more networks, to the one or more computing devices of the providing institution.

At a block 112, the providing institution may receive the confirmation. For example, the one or more computing devices of the providing institution may electronically receive the confirmation generated by the external institution, e.g., via a network interface.

At a block 115, upon receiving the confirmation that applicant or new account owner is indeed associated with the external, source financial account, the method 100 may include initiating an electronic funds transfer (EFT) from the external, source financial account to the new financial account. The EFT may then proceed, using conventional or any suitable methods of EFT.

At a block 118, the electronically transferred funds may be electronically received from the external, source account, and the new financial account may be credited with the monetary value of the electronically transferred funds, e.g., as an initial contribution or seed of the new financial account.

At a block 120, the new financial account may be activated for use. The new financial account may be activated immediately after the financial account has been credited, or the new financial account may be activated after the financial account has been credited and after other steps (not shown) in opening the new financial account have been performed (e.g., receiving wet signatures, verifying tax identification numbers, etc.). In some scenarios, a new financial account may be activated when the new account has a zero balance or before the new account has been funded.

At a block 122, the applicant or new account owner may be notified of the activation of the new financial account. For example, an indication of the account activation may be caused to be delivered to or presented at a user interface, and/or the indication of the account activation may be caused to be transmitted to a computing device associated with the applicant or new account owner. In an embodiment, a physical notification (e.g., a paper letter) may be caused to be generated (block 122) and sent to the applicant or new account owner.

The method 100 provides numerous benefits over known external account validation techniques, and over micro-deposits in particular. Specifically, using the techniques of method 100, an external source financial account may be validated in real-time, so that the applicant or new account owner does not need to incur lengthy delays before the new account is activated and funds are accessible. Additionally, the applicant or new account owner (or agent thereof) is not required to take any explicit, active verification steps (or remember to take active verification steps) during the real-time validation process. Rather, the validation process occurs in real-time without any manual interaction (e.g., without requiring logging into the external source account, for example, to verify micro-deposits or other information) at all. As such, the process to open a new financial account, e.g., electronically, appears seamless to a user.

Indeed, in an embodiment, the method 100 may be entirely performed during a single session established by a user. For example, the new account owner or agent thereof may establish a session at a website of the providing institution, and the method 100 may be entirely performed during the single session of the website, without requiring any additional sessions. In an embodiment, at least the blocks 102 through 115 of the method 100 may be performed during a single session.

In an embodiment, the method 100 (or at least the blocks 102-115 of the method 100) may be performed during a continuous time interval no longer than one (a single) business day. For example, the method 100 (or at least the blocks 102-115 of the method 100) may be performed in less than an hour, less than 30 minutes, less than 15 minutes, less than 10 minutes, or less than 5 minutes. The blocks 118-120 may be performed during the same continuous time interval in which the blocks 102-115 were performed, or the blocks 118-120 may be performed during another time interval occurring non-contiguously after the time interval in which the blocks 102-115 were performed. In an embodiment, the block 122 may be performed during the same contiguous time interval as the blocks 118-120. In an embodiment, the block 122 may be performed during a different time interval that is non-contiguous with the time interval in which the blocks 118-120 were performed, such as when customer notifications are generated by the providing institution in a batch.

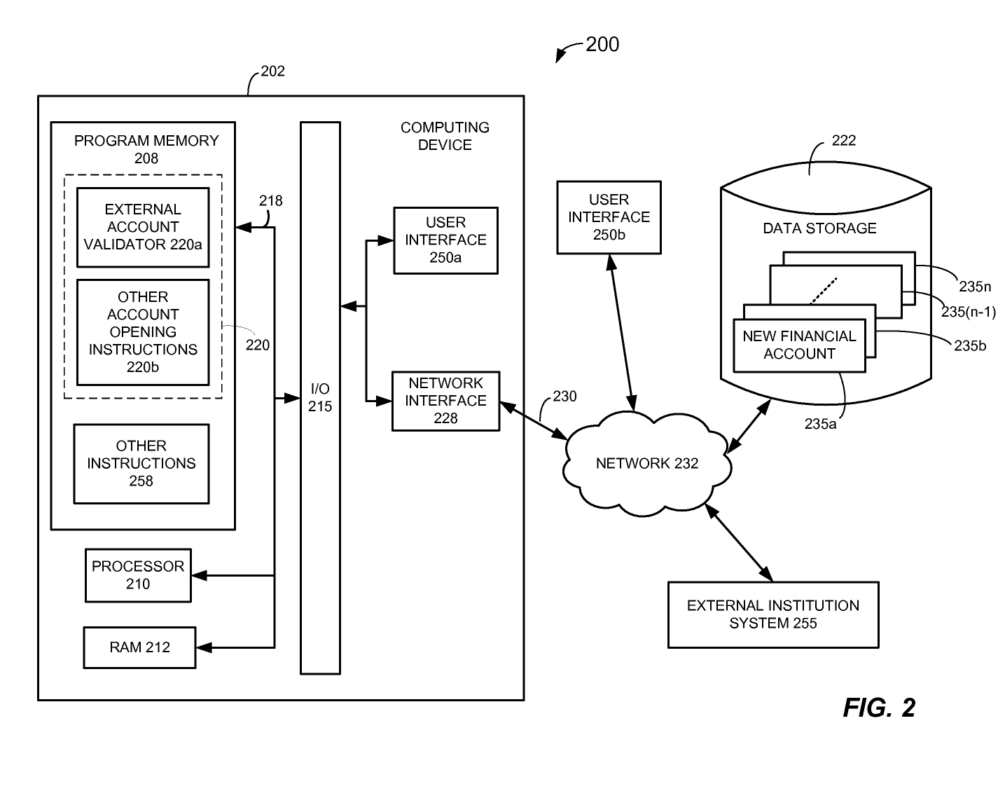

Turning now to FIG. 2, FIG. 2 illustrates a block diagram of an exemplary system 200 for opening financial accounts in real-time, e.g., for opening, in real-time, a new financial account provided by an institution. The system 200 may execute at least a portion of the method 100, in an embodiment. The system 200 may execute at least a portion of a method for opening a financial account in real-time other than the method 100, in an embodiment.

The system 200 may include a computing device 202 which may be, for example, a computer, a server, a plurality of networked computing devices having a logical appearance of a single computing device, a plurality of cloud computing devices, etc. Accordingly, for ease of discussion only and not for limitation purposes, the computing device 202 is referred to herein using the singular tense, although in some embodiments the computing device 202 may include more than one physical computing device.

The computing device 202 may include a program memory 208, a processor 210 (may be called a controller, a microcontroller, or a microprocessor), a random-access memory (RAM) 212, and an input/output (I/O) circuit 215, all of which may be interconnected via an address/data bus 218. The program memory 208 may comprise one or more tangible, non-transitory computer-readable storage media or devices, and may be configured to store computer-readable instructions 220 that, when executed by the processor 210, cause the computing device 202 to implement the opening of financial accounts in real-time. In an embodiment, the instructions 220, when executed, may cause the computing device 202 to implement at least a portion the method 100 of opening a financial account in real-time. The instructions 220 may include a first portion 220a for validating external accounts, which is referred to herein for ease of discussion as an “external account validator 220a,” and a second portion 220b, in an embodiment. The second portion 220b may include instructions for opening a new financial account other than external account validation instructions, e.g., instructions for causing an EFT to be initiated, causing the new account to be credited, causing a user notification to be generated, etc.

The computing device 202 may be configured or adapted to access one or more data storage devices 222. For example, the account opening instructions 220 may be executable by the processor 210 to access the one or more data storage devices 222. Additionally or alternatively, one or more other sets of computer-executable instructions 258 may be executable by the processor 210 to access the one or more data storage devices 222.

The one or more data storage devices 222 may comprise, for example, one or more memory devices, a data bank, cloud data storage, or one or more other suitable data storage devices. In the embodiment illustrated in FIG. 2, the computing device 202 is shown as being configured to access the one or more data storage devices 222 via a network interface 228 that is coupled to a link 230 in communicative connection with the one or more data storage devices 222. The link 230 in FIG. 2 is depicted as a link to one or more private or public networks 232 (e.g., the one or more data storage devices 222 are remotely located from the computing device 202), although this is not required. The link 230 may include a wired link and/or a wireless link, or may utilize any suitable communications technology.

In an embodiment (not shown), at least one of the one or more data storage devices 222 is included in the computing device 202, and the processor 210 of the computing device 202 (or the instructions 220, 258 being executed by the processor 210) accesses the one or more data storage devices 222 via a link comprising a read or write command, function, application programming interface, plug-in, operation, or instruction, or similar.

The one or more data storage devices 222 may include one physical device, or the one or more data storage devices 222 may include more than one physical device. The one or more data storage devices 222, though, may logically appear as a single data storage device irrespective of the number of physical devices included therein. Accordingly, for ease of discussion only and not for limitation purposes, the data storage device 222 is referred to herein using the singular tense.

The data storage device 222 may be configured or adapted to store data related to the system 200. For example, the data storage device 222 may be configured or adapted to store information corresponding to a new financial account 235a, such as an account number or identifier, a name and/or numerical identifier of the account owner, owner address, owner social security number, current balance, transaction records, etc. The data storage device 222 may be configured to store respective information corresponding to a plurality of accounts 235a-235n, each of which may be an existing or a new account.

With further regard to FIG. 2, in an embodiment, the external account validator 220a is configured or adapted to cause changes or updates to the entries 235a-235n. For example, the external account validator 220a may cause external source account information and/or source account validation information (e.g., as described with respect to block 108 of FIG. 1) to be stored in the entry 235a corresponding to a new financial account. The external source account information may include information that identifies or is indicative of the external source financial account, and may include information corresponding to and/or indicative of a system 255 corresponding to the external institution, e.g., a routing number corresponding to the external institution, a postal address of the external institution, a website of the external institution, and/or an electronic address of one or more computing devices corresponding to the external institution. For example, the computing device 202 may cause a transmission to be sent to the external institution system 255 via the network 232 using the stored electronic address of the external institution system 255.

In FIG. 2, although the computing device 202 is shown as being in communicative connection with a single computing system 255 corresponding to a particular external institution, the computing device 202 may be in communicative connection to any number of computing systems 255 (e.g., zero, two, three, or more computing devices) corresponding to the particular external institution. Additionally or alternatively, the computing device 202 may be in communicative connection with the computing system corresponding to the external institution system 255 as well as with any number of other computing systems respectively corresponding to any number of other external institution systems (not shown).

Turning again to the computing device 202, while the external account validator 220a is shown as a single block in FIG. 2, it will be appreciated that the external account validator 220a may include a number of different programs, modules, routines, and sub-routines that may collectively cause the computing device 202 to implement the external account validator 220a. Similarly, while the other instructions for opening a new financial account 220b is shown as a single block, it will be appreciated that the other instructions for opening a new financial account 220b may include a number of different programs, modules, routines, and sub-routines that may collectively cause the computing device 202 to implement the other instructions for opening a new financial account 220b.

Further, the computing device 202 may include other instructions 258, in an embodiment. For example, the other instructions 258, when executed by the processor 210, may host a website of the providing institution, administer a user interface 250, cause existing financial accounts to be credited and debited, and the like. In an embodiment, at least a portion of the instructions 220 for opening a new account and at least a portion of the other instructions 258 may be an integral set of instructions.

It should be appreciated that although only one processor 210 is shown, the computing device 202 may include multiple processors 210. Additionally, although the I/O circuit 215 is shown as a single block, it should be appreciated that the I/O circuit 215 may include a number of different types of I/O circuits. Similarly, the memory of the computing device 202 may include multiple RAMs 212 and multiple program memories 208. Further, while the instructions 220 for opening a new financial account and the other instructions 258 are shown being stored in the program memory 208, the instructions may additionally or alternatively be stored in the RAM 212 or other local memory (not shown).

The RAM(s) 212 and program memories 208 may be implemented as semiconductor memories, magnetically readable memories, chemically or biologically readable memories, and/or optically readable memories, or may utilize any suitable memory technology. The computing device 202 may also be operatively connected to the network 232 via the link 230 and the I/O circuit 215. The network 232 may be a proprietary network, a secure public internet, a virtual private network or some other type of network, such as dedicated access lines, plain ordinary telephone lines, satellite links, combinations of these, etc. Where the network 232 comprises the Internet, data communications may take place over the network 232 via an Internet communication protocol, for example.

Additionally, the user interface 250 may be integral to the computing device 202 (e.g., the user interface 250a), and/or the user interface may not be integral with the computing device 202 (e.g., the user interface 250b). For example, the user interface 250 may be a remote user interface 250b at a remote computing device, such as a web page or a client application.

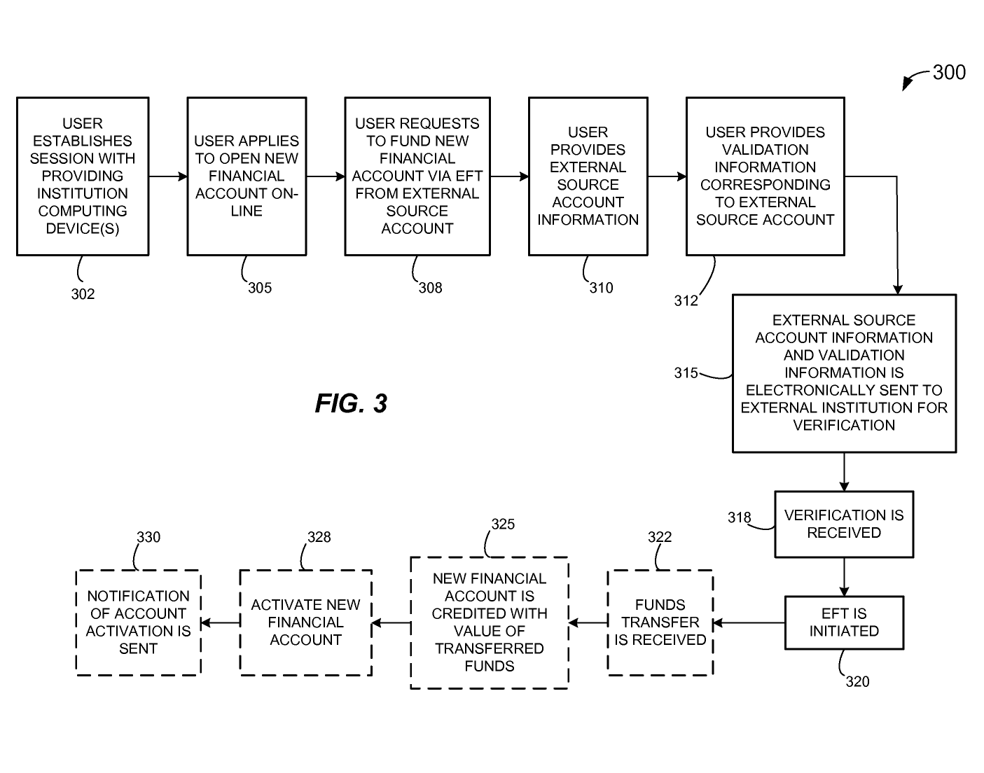

FIG. 3 is an example scenario or flow 300 illustrating the opening of a new financial account in real-time. In particular, the example scenario 300 illustrates an example real-time and seamless user experience that is able to be provided while utilizing the techniques, methods and systems described herein.

Indeed, the scenario 300 may occur in conjunction with any of the methods, techniques and/or systems described above or portions thereof, either alone or in combination. For ease of discussion, the example scenario 300 is discussed below with simultaneous reference to the method 100 of FIG. 1 and the system 200 of FIG. 2, however, the example scenario 300 may be supported by methods other than the method 100 and/or by systems other than the system 200.

Referring to block 302, a user may establish a session with a computing device corresponding to an institution that provides financial accounts, e.g., a “providing institution.” The user may be a customer, client, or member of the providing institution, or the user may be any entity that is eligible to open a new financial account at the providing institution. In some cases, the user may be an agent of the customer, client, member, or entity that is eligible to open a new financial account at the providing institution. In an embodiment, the session is established with a local computer, e.g., using the user interface 250a of the computing device 202 of FIG. 2, which may be located in an office of the providing institution, for example. In an embodiment, the session is remotely established, e.g., via a user interface 250b at the user's computing device and the network 232 with a website, a server, or a network hosted by or corresponding to the providing institution. In an embodiment, the session is a secured session.

During the established session, the user may apply for or open a new financial account (block 305). For example, the user may electronically apply to open a new financial account by requesting an electronic application form and entering data into the form, e.g., information indicative of the applicant or new account owner and other information.

The user may request that the new financial account be initially funded via an electronic funds transfer from a source financial account (block 308). The user may request the EFT during the established session, for example. In an embodiment, the user may request an EFT (block 308) during the application process. In an embodiment, the user may request an EFT (block 308) after the application has been approved and the new financial account has been opened and/or activated.

The source financial account may be provided by another institution 255, e.g., an “external institution,” and the user may provide information identifying and/or corresponding to the external source financial account and the external institution (block 310). For example, the user may provide an identifier of the external institution 255 and the account number or identifier of the external source financial account by entering this information into the electronic application form or into another electronic form or screen. In an embodiment, the external account validator 220a receives the information identifying and/or corresponding to the external source financial account. In an embodiment, the received information is stored, e.g., in the data storage entity 222.

The user may also provide validation information corresponding to the external source account (block 312). The validation information may be used by the external institution 255 to verify, validate or confirm that the applicant or account owner of the new financial account is associated with the external source financial account, and, in some cases, that the applicant or new account owner is authorized to withdraw funds from the external source financial account. The validation information may include, in an embodiment, a login and/or a password via which the applicant or new account owner accesses the external source financial account. In an embodiment, the validation information may exclude a login and/or a password, but may include other information corresponding to the applicant or new account owner, e.g., a social security number, an identifier or number corresponding to the applicant or new account owner, an answer to one or more security questions, and/or other validation information. In an embodiment, the external account validator 220a receives the validation information. In an embodiment, the received information is stored, e.g., in the data storage entity 222. In an embodiment, an indication that validation information corresponding to the external account and/or to its owner has been received is stored, e.g., in the data storage entity 222.

In an embodiment, the validation information may be provided by the user a priori. For example, if the applicant or new account owner has other active accounts with the providing institution, and the providing institution has previously stored validation information corresponding to other active accounts, the external account validator 220a may simply retrieve the stored validation information.

In an embodiment, at least some of the validation information may have already been provided when the user entered data into the new account application (block 305). In this embodiment, the external account validator 220a may simply retrieve the previously entered information for use as validation information.

In an embodiment, the type(s) of validation information that is to be provided by the user (block 312) may be specified by the external institution 255. For example, the external account validator 220a may query a computing device of the external financial institution 255 (either as part of the flow 300, or a priori) for the type(s) of validation information that the external financial institution 255 requires for validation of accounts provided by the external financial institution 255, and optionally, for the type(s) of validation information that the external financial institution 255 requires for validation of the party or parties that are authorized to withdraw funds from the accounts. The external account validator 220a may receive and store indication(s) of the type(s) of required validation information corresponding to the external institution 255, e.g., in the data storage entity 222. As such, during the flow 300, the external account validator 220a may prompt the user to enter the specific type(s) of validation information particularly required by the external institution 255. It is noted that different external institutions may require different types of validation information. In some cases, a particular external institution may require different types of validation information for different types of accounts, different amounts of withdrawal, and/or other criteria, and the respective types of validation information for the different criteria may be received and/or stored, e.g., in the data storage entity 222.

Turning to the block 315, the external source account information and the validation information may be electronically transmitted to a computing device of the external institution 255. For example, the external account validator 220a may cause the external source account information and the validation information to be electronically transmitted to the external institution 255 using the network interface 228 and the network 232. In an embodiment, an indication that validation information corresponding to the external account and/or to its owner has been transmitted to the external institution 255 is stored, e.g., in the data storage entity 222.

At a block 318, a confirmation of a validation of the association between the external source financial account and the applicant or new account owner may be received. For example, a computing device at the external institution 255 (e.g., the computing device which received the external source account information and the validation information, or another computing device) may generate an electronic confirmation, and may transmit the electronic confirmation to the computing device 202 of the providing institution, e.g., via the network 232 and the network interface 228 of the computing device 202.

In an embodiment, the external account validator 220a may receive the confirmation, and based on the affirmative confirmation, the external account validator 220a may cause an electronic funds transfer process to be initiated (block 320). In an embodiment, the external account validator 220a initiates the EFT process (block 320). In an embodiment, the external account validator 220a triggers the execution of other computer-executable instructions 220b and/or 258 to initiate the EFT (block 320).

At a block 322, the electronic funds transfer may be received. For example, the electronic funds transfer may be received at the computing device 202 via the network 232 and the network interface 228. Upon reception, the new financial account may be credited with the value of the transferred funds (block 325). In an embodiment, the external account validator 220a and/or the other instructions 220b and/or 258 may cause the new financial account to be credited with the value of the transferred funds.

The crediting of the new financial account may cause the new financial account to be activated (block 328), and the activation of the new financial account may cause a notification to be generated and/or sent to the user, applicant, and/or new account owner (block 330). In an embodiment, the external account validator 220a and/or the other instructions 220b and/or 258 may cause the activation of new financial account (block 328) and/or the notification to be generated and/or sent (block 330).

In an embodiment, the entire flow 300 may be performed during the single session that was established (block 302). In an embodiment, the solid-lined blocks (e.g., the blocks 302-320) may be performed during the single session.

In an embodiment, a first portion of the flow 300 (e.g., the blocks 302-315) may be performed during the first session, a second portion of the flow (e.g., the blocks 318 and 320) may be performed during another session, and a third portion of the flow (e.g., the blocks 322-328 or the blocks 322-330) may be performed during yet another session. This embodiment may occur, for example, if the external institution 255 is not capable of providing responses in real-time.

In an embodiment, the entire flow 300 may be performed during an interval of time less than or equal to one business day. In an embodiment, the solid-lined blocks (e.g., the blocks 302-320) may be performed during the interval of time less than or equal to one business day (e.g., during a first business day), and the dashed-lined blocks (e.g., the blocks 322-330) may be performed during a subsequent business day, e.g., during an interval of time less than one business day.

It is noted that although the above methods, techniques and systems are described with respect to opening a new financial account at a providing institution, any of the methods, techniques and systems described above (or portion(s) thereof, either alone or in combination) equally apply to funding an existing financial account at the providing institution using an EFT from an external source account. For example, an account owner of an existing financial account may request that funds be transferred from an existing, external source account to replenish the balance of the existing financial account.

Although the foregoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and systems described herein are illustrative only and are not limiting upon the scope of the claims.

1. A system for opening financial accounts in real-time, comprising:
a data storage device configured to store respective information corresponding to each of a plurality of accounts;
a network interface communicatively coupling the system to another system; and
an external account validator communicatively coupled to the data storage device and to the network interface; the external account validator configured to cause the system to:
(a) receive, via the network interface or via another interface of the system, a first request to open a new financial account at a first institution, wherein the new financial account, after being opened, is associated with an owner of the new financial account;
(b) store information corresponding to the new financial account in an entry of the data storage device, the information corresponding to the new financial account including an indication of the owner of the new financial account and an indication of an account balance;
(c) receive, via the network interface or the another interface, a second request to fund the new financial account by an electronic funds transfer from a source financial account corresponding to a second institution;
(d) cause a query to be transmitted, using the network interface, to a first computing device of the another system and corresponding to the second institution, to determine a particular type of validation information of a plurality of types of validation information, the particular type of validation information specified by the second institution, and each type of validation information included in the plurality of types of validation information is indicative of associations between accounts and account owners;
(e) obtain, via the network interface or the another interface, (i) information indicative of the source financial account, and (ii) validation information indicative of the new financial account owner, the validation information having the particular type indicated in a response to the query;
(f) cause the information indicative of the source financial account and the validation information indicative of the new financial account owner to be transmitted, using the network interface, to the first computing device or to another computing device for validation that the new financial account owner is associated with the source financial account, the another computing device corresponding to the second institution;
(g) receive, via the network interface, a validation indication that the new financial account owner is verified as being associated with the source financial account, the validation indication generated by the first or the another computing device corresponding to the second institution; and
(h) upon receiving the validation indication, initiate an electronic funds transfer from the source financial account to the new financial account, and update the information corresponding to the new financial account stored in the entry of the data storage device based on the electronic funds transfer,
wherein (a) through (h) is performed during a contiguous interval of time less than or equal to one business day.

2. The system of claim 1, wherein the external account validator is further configured to cause the system to:
(h) receive, via the network interface, the electronic funds transfer from the source financial account;
(i) based on the received electronic funds transfer, activate the new financial account including causing a value of the received electronic funds transfer to be credited to the new financial account; and
(j) transmit, via the network interface or via a user interface, an indication of the activation of the new financial account.

3. The system of claim 2, wherein the one business day is a first business day, and wherein (h) and (i) are performed during a second business day occurring after the first business day.

4. The system claim 1, wherein the first request is received at a website corresponding to the external account validator.

5. The system of claim 1, wherein (a) through (g) are performed during a single session established by the external account validator.

6. The system of claim 1, wherein the validation information indicative of the new financial account owner includes information indicative of the new financial account owner other than a login and/or a password.

7. The system of claim 1, wherein the new financial account is a bank account.

8. The system of claim 1, wherein the new financial account is one of a deposit account, an investment account, or a stored value card.

9. (canceled)

10. The system of claim 1, wherein the external account validator is further configured to cause the system to store, in the data storage device, an indication of the particular type of validation information specified by the second institution indicative of the association of the source financial account and the new financial account owner.

11. A system for opening a new financial account in real-time, comprising:
a data storage device configured to store information corresponding to a plurality of accounts including, for each account, an indication of an identifier of a respective account and an indication of an owner of the respective account;
at least one computing device communicatively connected to the data storage device and having a processor, a non-transitory, tangible memory, a user interface, and a network interface, the network interface communicatively connecting the at least one computing device to a network; and
a set of computer-executable instructions stored on the memory, thereby particularly configuring the at least one computing device, the set of computer-executable instructions executable by the processor to cause the at least one computing device to:
(a) receive, via the network interface or the user interface, a first request to open the new financial account for a party, the new financial account corresponding to a first institution, and generate an entry in the data storage device corresponding to the new financial account;
(b) receive, via the network interface or the user interface, a second request to fund the new financial account by an electronic funds transfer from a source financial account corresponding to a second institution;
(c) query, via the network interface, a first computing device corresponding to the second institution to determine one or more particular types of validation information of a plurality of types of validation information, the one or more particular types of validation information specified by the second institution, and each type of validation information included in the plurality of types of validation information indicative of associations of parties and financial accounts;
(d) obtain, via the network interface or the user interface, (i) information indicative of the source financial account, and (ii) validation information indicative of the party, the validation information indicative of the party having a type indicated in a response to the query;
(e) cause the information indicative of the source financial account and the validation information indicative of the party to be transmitted via the network interface to a second computing device for validation that the party is associated with the source financial account, the second computing device corresponding to the second institution;
(f) receive, via the network interface, an electronic indication that the party is verified as being associated with the source financial account, the electronic indication generated by the first, second, or third computing device corresponding to the second institution; and
(g) upon receiving the electronic indication that the party has been verified by the second institution as being associated with the source financial account, initiate, via the network interface, the electronic funds transfer from the source financial account to the new financial account and update information stored in the entry in the data storage device corresponding to the new financial account based on the electronic funds transfer.

12. The system of claim 11, further comprising additional computer-executable instructions stored on the memory and executable by the processor to cause the at least one computing device to:
(h) receive, via the network interface, the electronic funds transfer from the source financial account, and cause the transferred funds to be credited to the new financial account; and
(i) based on the credit to the new financial account, activate the new financial account.

13. (canceled)

14. The system of claim 11, wherein at least one of the first request, the second request, the information indicative of the source financial account or the validation information indicative of the party is received via a website of the first institution.

15. The system of claim 11, wherein (a), (b), and (d) through (g) are performed during a single session established with a website of the first institution.

16. The system of claim 11, wherein the validation information indicative of the party includes at least one of: (i) login information corresponding to the party and to the source financial account, or (ii) an identifier corresponding to the party.

17. The system of claim 11, wherein the new financial account is one of a bank account, a deposit account, an investment account, or a stored value card.

18. (canceled)

19. The system of claim 11, wherein the at least one computing device includes more than one networked computing devices.

20. A system for opening, in real-time, a new financial account at a first institution, comprising:
a data storage device configured to store a plurality of entries corresponding to a plurality of financial accounts, each entry of the plurality of entries including an indication of an identifier of a respective financial account and an indication of an owner of the respective financial account; and
a computing device communicatively coupled to the data storage device and configured to cause changes to the plurality of entries of the data storage device, the computing device including a processor and a program memory comprising a non-transitory, tangible computer storage media storing executable instructions that, when executed by the processor, cause the system to establish a session with another computing device corresponding to a user, and during the established session:
(a) receive a first request to open the new financial account at the first institution, wherein the new financial account, after approval, is owned by an owner of the new account;
(b) cause a new entry corresponding to the new financial account to be generated at the data storage device, the new entry including an indication of the owner of the new financial account;
(c) receive a second request to fund the new financial account by an electronic funds transfer from a source financial account at a second institution;
(d) query a first computing device corresponding to the second institution to determine a particular type of validation information of a plurality of types of validation information, each type of validation information included in the plurality of types indicative of associations between accounts and account owners, and the particular type of validation information specified by the second institution;
(e) receive (i) information indicative of the source financial account, and (ii) validation information indicative of the owner of the new account, the validation information being of the particular type of validation information specified by the second institution;
(f) cause the information indicative of the source financial account and the validation information indicative of the owner of the new account to be electronically transmitted via a network to the first or second computing device of the second institution to validate that the owner of the new account is associated with the source financial account at the second institution;
(g) receive an electronic confirmation generated at the second institution, the electronic confirmation indicating that the owner of the new account is associated with the source financial account; and
(h) upon receiving the electronic verification, initiate the electronic funds transfer from the source financial account to the new financial account and update the new entry corresponding to the new financial account based on the electronic funds transfer.

21. The system of claim 20, wherein the session is established at a website of the first institution, the website of the first institution hosted by the at least the another computing device.

22. The system of claim 20, wherein:
the validation information indicative of the owner of the new account includes at least one identifier corresponding to the owner of the new account other than a login and/or a password; and
the new financial account is one of a bank account, a deposit account, a checking account, a savings account, a money market account, a certificate of deposit account, an investment account, or a pre-paid card.

23. The system of claim 20, wherein:
the executable instructions, when executed by the processor, further cause the system to:
receive, from the first computing device of the second institution, an indication of the particular type of validation information specified by the second institution to validate the association of the owner of the new account with the source financial account, and
store the indication of the particular type of validation information specified by the second institution in the program memory or in another tangible, non-transitory computer storage media that is accessible by the system; and
the received validation information is based on the stored indication of the particular type of validation information specified by the second institution.

24. The system of claim 23, wherein:
the program memory or the another tangible, non-transitory computer storage media includes a plurality of indications corresponding to a plurality of institutions; and
each indication included in the plurality of indications corresponds to a respective one or more particular types of validation information required by a respective institution to validate associations between accounts and account owners.

25. The system of claim 1, wherein the external account validator is further configured to cause the system to query a computing device of a third institution for one or more particular types of validation information specified by the third institution and indicative of associations between source financial accounts and new financial account owners.

26. The system of claim 11, wherein the one or more particular types of validation information specified by the second institution and indicative of associations of parties and financial accounts is based on at least one of: a type of financial account or an amount of a withdrawal.
